(19) United States
(12) Patent Application Publication
(10) Pub. No.: US 2003/0134122 A1
(43) Pub. Date: Jul. 17, 2003

(54) High conductivity transparent conductor formed using pulsed energy process

(76) Inventors: Paul Wickboldt, Walnut Creek, CA (US); Dan Toet, Mountain View, CA (US); Wonsuk Chung, Ithaca, NY (US)

Correspondence Address: Kenneth M. Kaslow, FlexlCs, Inc., 165 Topaz St., Milpitas, CA, 95035, US

(21) Appl. No.: 10/047,782

(22) Filed: Jan. 14, 2002

(51) Int. Cl. B32B 9/04

(52) U.S. Cl. 428/411.1; 428/412; 428/480

(57) ABSTRACT

A method of creating a highly conductive transparent layer on a substrate without subjecting the substrate to high temperatures is disclosed. Pulsed laser energy of a wavelength and energy fluence within a selected range is used to crystallize a selected amorphous material using a low number of pulses (optimally as few as one) to form highly electrically conductive thin films that are optically transparent at visible wavelengths. This method does not subject the substrate to sustained higher temperatures and accordingly is particularly suitable for making transparent conductive thin film structures on substrates such as plastic that do not tolerate sustained higher processing temperatures. The disclosed method may also be useful in manufacturing processes in which the substrate is composed of a material (such as glass, for example) that is itself heat tolerant, but in which at the time of creation of the conductive layer is a part of a structure containing a material that does not withstand high temperatures, such as a low temperature plastic or other polymer. A thermal barrier comprised of an oxide, nitride or polymer material may be deposited on the substrate before the precursor material to help insulate the substrate from the thermal effects of the energy directed at the precursor material.

### BACKGROUND OF THE INVENTION

1. Field of the Invention

The present invention relates to thin film structures that are optically transparent and have high electrical conductivity, and to methods for making them. More specifically, the present invention relates to a method of forming a high conductivity, transparent thin film at temperatures significantly lower than those used in conventional processes by means of a pulsed energy source, such as a laser.

2. Related Art

In the manufacture of passive display panels for such applications as computers, cellular telephones, and personal data assistants (“PDAs”), it is often desirable to form a layer or film of conductive material on a substrate before building the transistors that comprise the backplane that drives the display. In order for the display to function properly, both the substrate and the conductive layer must be substantially transparent to visible wavelengths of light, i.e. the transmissivity must be approximately 80% or better. The most commonly used material for this conductive layer is Indium Tin Oxide (“ITO”), a highly conductive transparent film. ITO is Indium Oxide, In₂O₃ in its pure form, which has been doped with tin to make an n-type material. The amount of oxygen present in a volume of ITO may also be varied. (In active displays, the conductive layer is over the backplane, but in this type of display the conductivity of the layer is not as critical as for passive displays.)

The microstructure of the ITO is highly dependent upon the temperature at which it is deposited, and determines its conductivity. At high deposition temperatures, the ITO forms a crystalline film with a resistivity that is significantly lower than the amorphous material deposited at lower temperatures. For example, an ITO thin film deposited using conventional techniques such as magnetron sputtering or evaporation at temperatures over 300° C. typically has a bulk resistivity of between 5×10⁻⁵ and 1×10⁻⁴ ohm-cm, while amorphous ITO fabricated at temperatures at or below 100° C. has a bulk resistivity on the order of 4×10⁻⁴ ohm-cm or greater.

An alternative method of obtaining crystalline ITO is depositing uncrystallized ITO and then crystallizing it, for example, depositing a layer on a substrate at low temperature and then annealing it at high temperatures in a furnace, again typically 250° C. or higher, to crystallize it.

Both of these conventional methods are used with substrates like quartz or glass that are able to withstand the sustained high temperatures to which they are subjected. Materials that are degraded or destroyed by exposure to high temperatures for extended times are unsuitable for use as substrates treated by such conventional methods.

A recent development in the manufacture of display panels and other applications is an interest in manufacturing the backplanes on plastic substrates rather than on standard glass, quartz or silicon wafer-based substrates. It is believed that the use of plastic substrates will result in displays that are 1) lighter in weight than present displays, 2) flexible, which will allow the fabrication of displays with different topologies, 3) unbreakable, which will help to prevent damage from mishandling such as impact or dropping of the device containing the display, and 4) lower in cost.

The physico-mechanical properties of the plastic substrate are very important for making flexible panel displays. In addition to requiring excellent dimensional stability of the film, characteristics such as surface and thickness uniformity, light transmission, surface scratch resistance, adhesion, chemical resistance and impermeability to moisture and gas play key roles in the development of liquid crystal display (“LCD”) and organic light emitting diode (“OLED”) displays.

The types of plastic for which these properties are suitable for use in displays are incapable of withstanding the processing temperatures used in the conventional ITO fabrication techniques described above. For example, while the plastic may be one of a variety of types having characteristics that make it acceptable for use as a substrate in a display device, most tests to date have utilized polyethylene terephthalate (PET) as the substrate material, which cannot withstand temperatures greater than about 120° C. (Polyethylene naphthalate (PEN) will withstand slightly higher temperatures, but still not high enough to take the temperatures of conventional processes.)

Some companies have manufactured passive displays utilizing ITO on plastic for such applications as cell phones, touch screens, and window treatments. As above, ITO has a bulk resistivity on the order of 4×10⁻⁴ ohm-cm when fabricated at temperatures near 100° C. For a film that is 1000 angstroms thick, this yields a theoretical sheet resistance of 40 ohms per square; in practice, it is closer to 60 ohms/square. While this has been adequate for low-density passive displays, it is not a low enough sheet resistance to make passive displays with a higher concentration of pixels. For such display applications, it is desirable to obtain a substantially lower sheet resistance, on the order of 5 to 10 ohms/square. (Again, the sheet resistance is not as critical for active displays, as the transistors in such displays provide a higher current.)

In addition, deposition of ITO at such a low temperature has been shown to result in a “two phase” material, the first few hundred angstroms of which may be amorphous and the remainder of which is polycrystalline. (For the purposes of this application, such “two-phase” ITO deposited at low temperatures shall be considered to be amorphous ITO.) This creates a layer that is very difficult to work with. First, the optical characteristics of both types of ITO and of the interface between the two types of ITO must be taken into account. Second, if the ITO is etched, for example to create an interconnect layer, such as by a wet etch process, the amorphous form of the ITO etches much faster than the polycrystalline form, on the order of 100 times faster, resulting in severe undercuts.

The only way to obtain a lower sheet resistance while still depositing the ITO at low temperature is to increase the thickness of the ITO layer, as a thicker layer of material of a given resistivity will have a lower resistance. However, this has other problems. Amorphous and polycrystalline ITO are not as transparent as crystalline ITO, and thus making the ITO thicker makes it less transparent. Also, as ITO gets thicker, optical interference effects begin to become significant. Companies depositing ITO on plastic have tried to avoid these effects by engineering multiple layers that minimize interference while increasing the thickness of the ITO to lower resistance. However, even with a thickness of ITO significantly greater than 1000 angstroms, sometimes as great as 3000 angstroms, the best products now available can only achieve a sheet resistance of 40 ohms/square and an optical transparency of 85%. The complexity and additional cost of these solutions also makes them unattractive for active display devices on plastic.

Accordingly, it is desired to find a method of fabricating a layer of a transparent conductive material like ITO at temperatures around 120° C., while retaining the low resistivity of ITO deposited at much higher temperatures.

### SUMMARY OF THE INVENTION

The invention is directed to employing pulsed energy processing for making transparent conductive thin film structures.

The method of the present invention employs pulsed laser energy at a wavelength, and at an energy fluence, within a selected range to crystallize a selected amorphous material using a low number of pulses (optimally as few as one) to form optically transparent, highly electrically conductive thin films. The method of the present invention does not subject the substrate to sustained higher temperatures and accordingly is particularly suitable for making transparent conductive thin film structures on substrates such as plastic that do not tolerate sustained higher processing temperatures.

The disclosed method may also be useful in manufacturing processes in which the substrate is composed of a material (such as glass, for example) that is itself heat tolerant, but in which at the time of creation of the conductive layer is a part of a structure containing a material that does not withstand high temperatures, such as a low temperature plastic or other polymer. Examples of this type of application include organic displays such as OLEDs.

The present invention features a method for forming a transparent conductive layer that contains the steps of providing a substrate; depositing on the substrate, at a temperature of 120° C. or less, a layer of amorphous and/or polycrystalline conductive material which is substantially optically transparent to visible wavelengths in its crystalline state; and directing pulsed energy onto the layer of conductive material to crystallize it and form the highly conductive, substantially optically transparent film. A thermal barrier comprised of an oxide, nitride or polymer material may be deposited on the substrate before the precursor material to help insulate the substrate from the thermal effects of the energy directed at the precursor material.

Other objects and advantages of the present invention will become apparent from the following description and accompanying drawings.

### DESCRIPTION OF THE DRAWINGS

The accompanying drawings, which are incorporated into and form a part of the disclosure, illustrate an embodiment of the invention and its method of use, and, together with the description, serve to explain the principles of the invention.

FIG. 1 is a cross-sectional view of a plastic substrate after thermal barrier and amorphous precursor material depositions, and illustrating pulsed laser irradiation, according to the present invention.

FIG. 2 is a cross-sectional view of a plastic substrate after amorphous material deposition, and illustrating pulsed laser irradiation, according to the present invention.

FIG. 3 is a diagram of the absorption characteristics of ITO.

### DETAILED DESCRIPTION OF THE PREFERRED EMBODIMENT

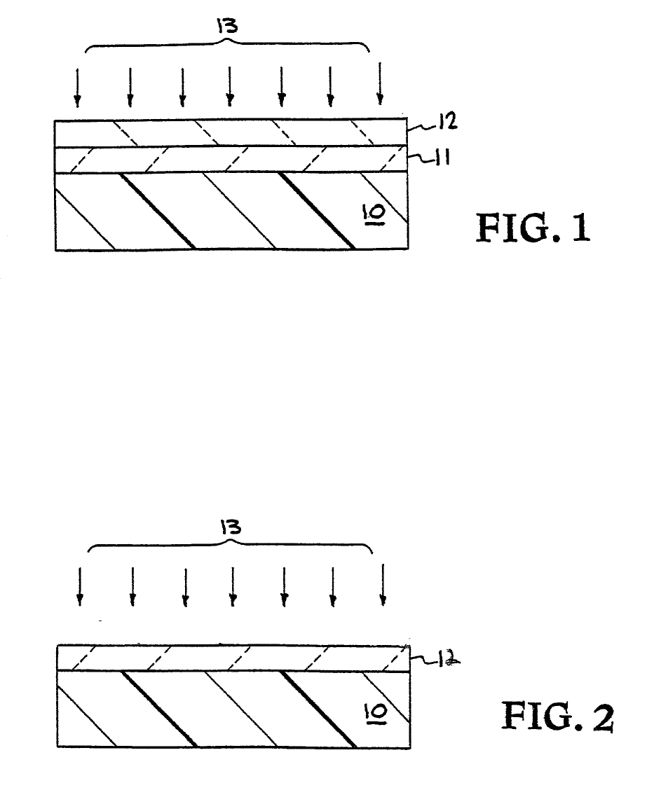

FIG. 1 illustrates one embodiment of the present invention. A plastic substrate 10, after cleaning and annealing if necessary, is coated with a first layer 11 of a thermally insulating dialectric material. This layer may be an oxide or nitride or a combination thereof, such as SiO₂, or a polymer layer such as that described in U.S. patent application Ser. No. 10/006,572, filed Dec. 6, 2001, or a combination of the two. In the case of an oxide or nitride, the layer 11 may be applied by sputtering, reactive sputtering, evaporation, reactive evaporation, chemical vapor deposition physical vapor deposition (PVD), plasma enhanced chemical vapor deposition (PECVD), or any other manner not requiring high temperatures, while the polymer layer may be applied by dipping or spinning.

The plastic may be one of a variety of types having characteristics that make it acceptable for use as a substrate in a display device. Most tests to date have utilized polyethylene terephthalate (PET) as the substrate material, which cannot withstand temperatures greater than about 120° C. Other materials having suitable characteristics are believed to include polyethylene naphthalate (PEN), polycarbonate (PC), polyarylate (PAR), polyetherimide (PEI), polyethersulphone (PES), polyimide (PI), Teflon polyperfluoro-alboxy fluoropolymer (PFA), polyether ether ketone) (PEEK), polyether ketone (PEK), polyethylene tetrafluoroethylenefluoropolymer (PETFE), and polymethyl methacrylate (PMMA) and various acrylate/methacrylate copolymers. Certain of these plastic substrates can withstand higher processing temperatures of up to at least about 200° C., and some to 300-350° C. without damage. However, none of these other materials appears to have the same overall suitability for use in displays as PET, including such characteristics as cost, transparency, and dimensional stability.

After deposition of the insulating layer 11, an amorphous film 12 of a transparent, conductive material having a thickness of 500 to 3000 angstroms (most commonly in the range of 800 to 1200 angstroms) is deposited on the insulating layer 11. The amorphous material used in tests thus far is ITO, a transparent, electrically conductive material, which has been deposited by reactive sputtering at a temperature of approximately 100° C. or less. In fact, the deposition has even been done at room temperature, i.e. 20 to 25° C.

In the alternative embodiment of FIG. 2, amorphous ITO film 12 is deposited directly on plastic substrate 10 and there is no insulating layer.

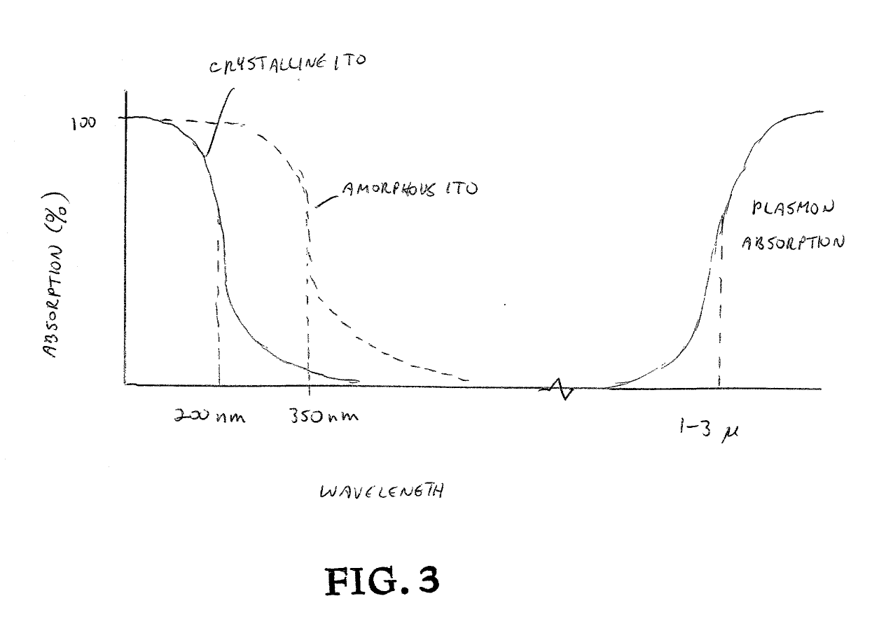

The amorphous precursor film 12 is then annealed to form a crystalline ITO film by irradiating it with one or more laser pulses, as indicated at 13 in FIG. 1. An excimer laser has been used in testing to date, in particular an XeCl excimer laser having a 308 nm wavelength. This wavelength was used because the absorption spectra for ITO, shown in FIG. 3, shows that a significant amount of energy is absorbed by the ITO at this frequency rather than transmitted through to the substrate. It should be noted that while the absorption of the ITO will change significantly in the plasmon absorption region and slightly in the crystalline form depending upon the amount of tin used to dope the Indium Oxide, the curve for amorphous ITO is almost independent of the tin concentration.

It is believed that a KrF excimer laser operating at 248 nm would also prove to be satisfactory, and perhaps even better, for the same reason. (While the absorption spectra indicates that wavelengths under 200 nm would be preferable, pulse lasers operating at such wavelengths are expensive and somewhat impractical due to their high cost.) Alternatively, it is believed that, due to the rise in absorption by ITO in the mid-infrared range, 1 to 3 μm (via plasmon absorption), an Erbium doped YAG laser or other energy source operating at a wavelength of 2.97 μm would also prove to be satisfactory, as again most of the energy would be absorbed by the ITO rather than transmitted through to the substrate. The use of an energy source with this wavelength would have the added advantage that any energy not absorbed by the ITO would pass through the plastic substrate, as it is believed that virtually all of the plastics mentioned herein are transparent to infrared radiation. This would also allow the ITO to be pre-patterned if desired, rather than deposited in an entire layer and etched later.

It can be seen in FIG. 3 that the absorption of energy by ITO at 308 nm (or 248 nm) drops significantly if the ITO is crystalline, rather than amorphous. For this reason, it is desirable to crystallize the ITO with as few laser pulses as possible, as the absorption from each pulse will drop as the ITO converts from the amorphous to the crystalline form, and more energy will be transmitted through to the substrate, increasing the risk of damage to a low temperature substrate such as plastic.

It is possible that this problem could be alleviated by engineering a barrier layer between the ITO and the plastic substrate that is not only heat resistant but also reflects energy at the wavelength of the laser, for example by adjusting the indexes of refraction in multiple layers. Such solutions add complexity and cost to the manufacturing process. Thus, ideally there should be enough energy in a single laser pulse to crystallize the ITO. In tests, crystallization of a 1000 angstrom layer of ITO was accomplished with a single pulse from the 308 nm XeCl excimer laser having a fluence of 150 millijoules per square centimeter (mJ/cm²).

In tests using this method on glass, a sheet resistance of 25 ohms/square was obtained with a 1000 angstrom layer of ITO, and optical transmission of 80 to 85% of the incident visible light. No other comparable results using a low temperature deposition of ITO are known; rather, as above, it is believed that even a sheet resistance of 40 ohms/square has been obtained only by using a layer of ITO that is significantly thicker than 1000 angstroms.

The exact composition of the ITO may be varied by varying the amount of tin added to the Indium Oxide, or by varying the amount of oxygen present. In practice it is easier to vary the amount of oxygen, as this may be done during either during sputtering or annealing by varying the amount of oxygen present in the chamber during these processes. Less oxygen makes the ITO more conductive as well as darker, and it may even approach being opaque before annealing if the oxygen content is low enough.

This significantly increases the amount of energy absorbed by the amorphous ITO, i.e. “higher quality” (higher transparency in the visible range, i.e. 500 to 600 nm) amorphous ITO is less satisfactory, because it does not absorb the laser pulse well, so the laser treatment does not effect a suitable anneal. A “poorer” (lower transparency in the visible range) amorphous ITO is better; it is presently believed that an amorphous ITO film having 70% transmittance at 500 to 600 nm gives the best results.

The thickness of the ITO film may be adjusted as desired. However, it is believed that a thickness of approximately 1000 angstroms of crystallized ITO is necessary to keep the sheet resistance down to an acceptable level, while a thickness significantly greater than this leads to adverse optical effects as mentioned above.

As above, the optimal number of pulses used to crystallize the ITO is one. However, in the event that multiple pulses are needed, tests indicate that an exposure at a lower fluence, below the ablation threshold of the film, followed by an exposure at a higher fluence, works best. Also, it appears that a fluence of about 150 mJ/cm works best, with both sheet resistance and transmittance improving with the first few laser pulses, up to a limit (below the damage threshold), beyond which sheet resistance stays relatively constant. While a higher fluence of about 175 mJ/cm² also showed improvement in both sheet resistance and transmittance for a number of pulses, after this sheet resistance increased sharply. It is believed that these effects at least partly result from a reduction in absorption of the incident laser energy by the ITO as the transmittance in the visible range improves.

Other types of transparent conductive materials are under investigation by researchers, including Zinc Oxide, Zinc Stannate, Cadmium Stannate, Zinc Indium Oxide, Magnesium Indium Oxide and Gallium Indium Oxide. Although to date none of these appear to have characteristics as good as Indium Tin Oxide for the applications contemplated herein, they are within the contemplated scope of the present invention.

Although the tests to date have utilized an XeCl excimer laser, as mentioned above it is envisioned that other embodiments may utilize other types of pulsed lasers operating at similar or different frequencies than those specified herein. It is also contemplated that the annealing of the amorphous ITO could be accomplished with or an electron beam or ion beam.

It can thus be seen that films made according to the invention can have high conductivity and high optical transmittance, while providing uniform etch characteristics, so that the films may be formed into transparent, highly conductive thin film structures having fine features. Further, because few steps are required, and treatment of the ITO is accomplished with a single laser pulse, manufacturing time can be significantly reduced.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

What is claimed is:

1. A method for forming a highly conductive, substantially transparent film on a substrate, comprising:
providing a substrate;
depositing on the substrate, at a temperature of 120° C. or less, a layer of amorphous and/or polycrystalline conductive material which is substantially optically transparent to visible wavelengths in its crystalline state; and
directing pulsed energy onto the layer of conductive material to crystallize it and form the highly conductive, substantially optically transparent film.

2. The method of claim 1, wherein the step of providing a substrate further comprises providing a substrate composed of a material selected from the group consisting of PET, PEN, PC, PAR, PEL, PES, PI, Teflon PFA, PEEK, PEK, PETFE and PMMA.

3. The method of claim 1, wherein the step of providing a substrate further comprises providing a substrate coated with an optically transparent thermal insulating layer.

4. The method of claim 3, wherein the thermal insulating layer further comprises an oxide, a nitride and/or a polymer.

5. The method of claim 1, wherein the layer of conductive, transparent material is selected from the group containing Indium Tin Oxide, Zinc Stannate, Cadmium Stannate, Zinc Indium Oxide, Magnesium Indium Oxide and Gallium Indium Oxide.

6. The method of claim 1, wherein the step of depositing the conductive material on a surface of the substrate further comprises depositing the conductive material by sputtering, reactive sputtering, evaporation, reactive evaporation, chemical vapor deposition or plasma enhanced chemical vapor deposition.

7. The method of claim 1, wherein the step of directing pulsed energy onto the layer of conductive material further comprises the steps of:
generating an energy pulse from a laser, an electron beam source or an ion beam source; and
directing the energy pulse onto the layer of conductive material.

8. The method of claim 7, wherein the step of generating an energy pulse further comprises generating an energy pulse from an excimer laser or a YAG laser.

9. The method of claim 7 wherein the step of directing an energy pulse further comprises directing an energy pulse having a wavelength of between 200 and 400 nm onto the layer of conductive material.

10. The method of claim 9, wherein the step of generating an energy pulse further comprises generating an energy pulse from an excimer laser.

11. The method of claim 9, wherein the step of generating an energy pulse further comprises generating an energy pulse from a YAG laser.

12. A composite material for use in fabricating semiconductor display devices, comprising:
a substrate that is intolerant of temperatures greater than 350° C.; and
a layer of crystalline material that is highly conductive and substantially optically transparent to visible wavelengths on one surface of the substrate.

13. The composite material of claim 12, wherein the substrate is a material selected from the group consisting of PET, PEN, PC, PAR, PEL, PES, PI, Teflon PFA, PEEK, PEK, PETFE and PMMA.

14. The composite material of claim 12, wherein the layer of conductive, transparent material is selected from the group containing Zinc Oxide, Indium Tin Oxide, Zinc Stannate, Cadmium Stannate, Zinc Indium Oxide, Magnesium Indium Oxide and Gallium Indium Oxide.

15. A composite material for use in fabricating semiconductor display devices, comprising:
a substrate that is intolerant of temperatures greater than 350° C.;
a layer of thermal insulating material that is substantially optically transparent at visible wavelengths on one surface of the substrate; and
a layer of crystalline material that is highly conductive and substantially optically transparent at visible wavelengths on the opposite surface of the layer of insulating material from the substrate.

16. The composite material of claim 15, wherein the layer of insulating material further comprises one or more layers of an oxide, a nitride and/or a polymer.

17. The composite material of claim 15, wherein the substrate is a material selected from the group consisting of PET, PEN, PC, PAR, PEL, PES, PI, Teflon PFA, PEEK, PEK, PETFE and PMMA.

18. The composite material of claim 15, wherein the layer of conductive, transparent material is selected from the group containing Zinc Oxide, Indium Tin Oxide, Zinc Stannate, Cadmium Stannate, Zinc Indium Oxide, Magnesium Indium Oxide and Gallium Indium Oxide.
